(19) United States
(12) Patent Application Publication
(10) Pub. No.: US 2009/0007092 A1
(43) Pub. Date: Jan. 1, 2009

(54) Flashed based data aggregation and exchange

(75) Inventor: Jesse J. Wolfe, Campbell, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/824,279

(22) Filed: Jun. 28, 2007

(51) Int. Cl. G06F 9/44

(52) U.S. Cl. 717/173

(57) ABSTRACT

A system and method for affecting global change to application instance windows or applications at a client side device are disclosed herein. New and/or substitute feature, content, and/or functionality can be provided to application instance windows or applications that use flash player technology. The implementation of the new feature, content, and/or functionality may be toggled on/off by the user or it may be automatically provided to the user. The implementation affects no permanent change to the application instance windows or applications. Rather it drives user customization, improves user experience, and provides a way to potentially generate revenue.

### BACKGROUND OF THE INVENTION

The present invention relates to a computer-implemented system for communication via a network such as the Internet. More particularly, the present invention relates to environment and/or contextual controllers for computer-implemented systems.

The Internet provides various ways for users to communicate with other users. Popular forms of communication include electronic mail (email) and instant messaging (IM). IM can be implemented using a local application or a web-based application. An advantage of local application implementation is the ability to customize the user interface. The user can specify various interface parameters such as font size, color, width of window, background image, numerous sub-folders, etc. The disadvantage of local application implementation is the inability to access the application at a different machine, or even if another machine has the local application, the user's particular settings and other locally saved information would not be available.

Implementing the web-based application, on the other hand, allows the user to access the application from any machine, provided the machine can communicate with a server that provides the web-based application. User settings and other saved information are similarly available from any such machine, because content, such as IM histories and contact lists, are user (or account) specific. The user interface, however, may not be user specific because customization is not allowed or customization applied to a currently open window cannot be saved for future sessions (e.g., the user opens a window and then resizes the window, but the “new” window size does not carry over to other windows). Limited customization features exist because of, in part, memory cost, network bandwidth limitation, to fulfill users' demand for robust accessibility over customization features, and/or the goal to emphasis providing dynamic content over user customization features.

In recent years, as memory cost has decreased and more users have access to high speed Internet connections, web-based applications are providing more customization features. Customization may be provided from the web-based application itself, via cookies loaded on the user's machine, or additional applications that work in conjunction with the web-based application. Adding customization features to the web-based application makes the web-based application large and may be more than what most users need. These unused features are inefficient use of network bandwidth. Cookies may be too easy to delete and cannot be differentiated from spam, for example, web browsers that automatically delete cookies upon closing or which block cookies from loading on the user machine. Additional applications working in conjunction with the web-based application suffer from compatibility and/or limited integration issues. The web-based application may only permit limited change to the user interface.

Thus, it would be beneficial to provide customization features for a web-based application that does not impact network bandwidth. It would be beneficial to provide customization features that are robust but which maximize use of existing applications at a client side machine. It would be beneficial to provide a user specified “look and feel” across the entire user interface relating to the web-based application rather than to a single window of the web-based application. It would be beneficial to provide new or substitute features, content, and/or functionalities that are revenue generators. It would be beneficial to have a bridge for aggregating and exchanging data among multiple flash instances with minimal external security breach issues.

### BRIEF SUMMARY OF THE INVENTION

A persistent controller is operable to aggregate, store, and/or share data among flash-related instances. The data may originate from the persistent controller or may be extracted from flash-related instances. In one example, the persistent controller is downloaded from a server to a client device. The persistent controller includes features, content, and/or functionalities (collectively referred to as data). When the user accesses an application that uses flash-related instances, a communication bridge occurs between such flash-related instances and the persistent controller. The data included with the persistent controller can be presented to the user in the accessed application via the injection of the data by the persistent controller to the flash-related instances normally used with the application.

The “injected” data can be applied to all the windows of the application, or across different applications accessed by the user. Examples of “injected” data include window environment features (such as background color or pattern), user interface functionalities (such as an icon to initiate an instant messaging service), or content (such as targeted advertisement). Due to global sharing of data across all the windows of a given application or across multiple applications at the client device, uniformity and expansion of user experience may be achieved.

In another example, the persistent controller can aggregate data from flash-related instances (or other sources such as feeds from the server). When a user opens an application using a flash-related instance, the controller becomes aware of the flash-related instance and a connection is made between the controller and the flash-related instance. Once the connection is established, data from the application can be sent to the controller via the flash-related instance. The data can then be shared with other flash-related instances either immediately or at a later point in time or stored for later use. The other flash-related instances may be web based flash instances or local flash instances.

The data that is exchanged and/or stored may be what the user is searching for (e.g., search terms) or which links the user is clicking on in the opened application. All or part of such data may be stored or shared. For example, if the data comprises search terms, all of the data may be shared. But if the data comprises links, then intermediate comparisons or calculations may be performed to determine the category that the links fall within (e.g., shopping websites, search engines, periodicals, etc.). The data (in whatever form is deemed appropriate) can be used to present meaningful, accurate, and contextual information in other windows of the same open application or to other applications. The presentation of the data can also be tailored, such as using the user's previous search terms to provide targeted marketing graphics, suggested focused search terms, or trivia information relating to the previous search terms.

Accordingly, the controller is configured to bridge and manipulate multiple flash-related instances, to provide visual uniformity across windows of a given application or across multiple applications, and/or to aggregate and share data among disparate applications.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined by the claims attached hereto.

### BRIEF DESCRIPTION OF THE DRAWINGS

The exemplary embodiments will become more fully understood from the following detailed description, taken in conjunction with the accompanying drawings, wherein the reference numeral denote similar elements, in which:

FIG. 1 is a block diagram of a communication system in accordance with one embodiment of a controller.

FIG. 2 is a more detailed block diagram of a first client included in the communication system of FIG. 1.

FIG. 3 is a flow diagram illustrating a functional embodiment of the controller shown in FIG. 2.

FIG. 4 is an illustration of an instant message window with a default view conversation display area.

FIG. 5 is an illustration of an instant message window with a bubble view conversation display area.

FIG. 6 is a flow diagram illustrating another functional embodiment of the controller shown in FIG. 2.

In the drawings, to easily identify the discussion of any particular element or art, the most significant digit or digits in a reference number refer to the figure number in which that element is first introduced (e.g., element 1104 is first introduced and discussed with respect to FIG. 11).

The headings provided herein are for convenience only and do not necessarily affect the scope or meaning of the claimed invention.

### DETAILED DESCRIPTION OF THE PREFERRED EMBODIMENTS

Described in detail below is a system and method for globally providing a new and/or additional feature, content, and/or functionality to more than one window of a given application (also referred to as application instance windows or application windows) or more than one application using a flash player technology running at a local client device. A persistent controller at the local client device is operable to aggregate (and optionally store) data from flash instances and share such data with other flash instances either immediately or at a later point in time. The persistent controller acts as a bridge for manipulating multiple flash instances in a visually coordinated manner and/or act as a bridge for aggregating and sharing data between multiple flash instances.

In one embodiment, a controller comprising a flash instance or file is downloaded to the local client device from a server when a user interacts with the server. The controller persists at the local client device after the session with the server. The controller communicates with existing flash instances that are used to provide application windows or applications on the local client device, and causes the existing flash instances to add and/or substitute in the new feature, content, and/or functionality than would otherwise be provided to the user. Because the controller is not formally tied to other flash instances, the existing flash instances can execute without the controller, the existing flash instances can provide more/different features without changing all the existing flash instances, and as the controller changes, and so can the features of the existing flash instances without changing all the flash instances. Such modularity or building block concept fosters a better user experience, through user customization and feature expansion, and also provides an avenue for distribution of targeted marketing content.

Accordingly, the controller can affect a user's window environment, such as changing the conversation display area of multiple instant messaging chat windows from plain text (successive rows of text) to speech bubbles (text from each person in the chat session encapsulated in a outline shape or bubble), or providing a unique font to each of a web-based application, local browser application, and local word processing application. The controller can also affect a user's window content, such as displaying contextual advertisement on each of the web-based application, local browser application, and local media player application. The controller can also affect the user's interface by providing more functionality, such as providing the ability to launch an instant messaging chat session from, for example, a browser window, a word processing window, and desktop e-mail window without first opening the instant message application. The controller also has the ability to provide a feature, content, and/or functionality to application windows or applications that has a contextual relationship with the user's action (e.g., search terms) on the local client device.

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of the embodiments of the invention.

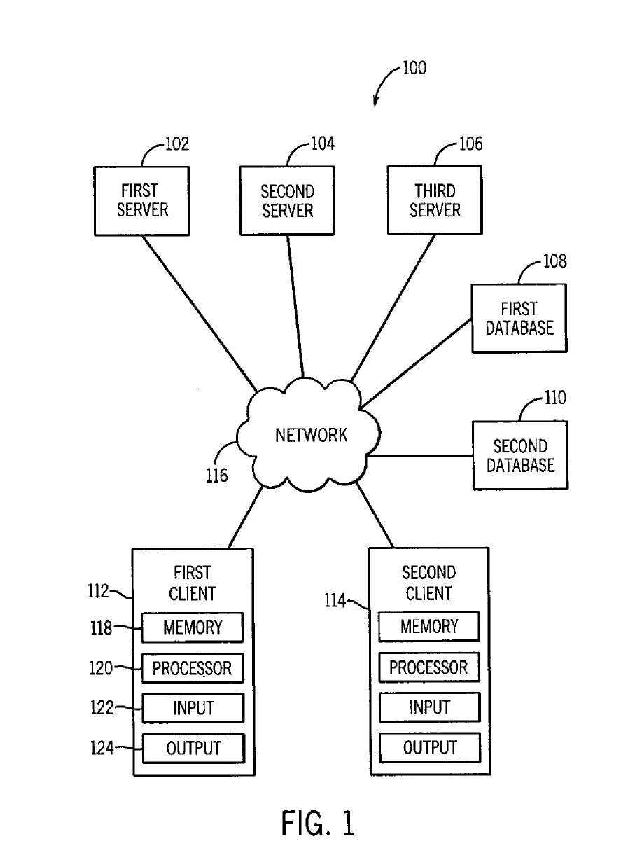

Referring to FIG. 1, a block diagram of one embodiment of a system 100 for providing client side environment and contextual content control is shown. The system 100 includes each of a first server 102, a second server 104, a third server 106, a first database 108, a second database 110, a first client 112, and a second client 114 in communication with a network 116.

The first, second, and third servers 102, 104, 106 are host servers operable to provide content and/or web-based application(s) to each of the first and second clients 112, 114 via the network 116. The first and second databases 108, 110 are operable to store data provided by the first, second, and/or third servers 102, 104, 106 and/or the first and second clients 112, 114. The first and second databases 108, 110 may communicate with any of servers 102, 104, 106 or clients 112, 114 via the network 116.

Alternatively, the servers 102, 104, 106 may include the databases 108, 110, processors, switches, routers, interfaces, and/or other components and modules. Each of the servers 102, 104, 106 may comprise one or more servers, or may be combined into a fewer number of servers than shown, depending on computational and/or distributed computing environments. The servers 102, 104, 106 may be located at different geographic locations relative to each other. The databases 108, 110 may also be located at different geographic locations relative to each other and to the servers 102, 104, 106. The databases 108, 110 may be directly connected to the servers 102, 104, 106. It is contemplated that there may be more or less than three servers, more or less than two databases, and/or more or less than two clients comprising the system 100.

The first client 112 includes a memory 118, central processing unit (CPU) 120, an input device 122, and an output device 124. The first client 112 may be a general purpose computer (e.g., personal computer). Other computer system configurations, including Internet appliances, hand-held devices, wireless devices, portable devices, wearable computers, cellular or mobile phones, portable digital assistants (PDAs), multi-processor systems, microprocessor-based or programmable consumer electronics, set-top boxes, network PCs, mini-computers, and the like may also be implemented as the first client 112. The first client 112 includes one or more applications, program modules, plug-ins, and/or sub-routines. As an example, the first client 112 can include a browser application (e.g., Internet Explorer, Firefox, etc.), Abode Flash Player, and a graphical user interface (GUI) to access web sites, web pages, or web-based applications provided by the servers 102, 104, 106 and data stored in the databases 108, 110. The second client 114 is similarly configured to the first client 112. The clients 114, 116 may be remotely located from each other, the servers 102, 104, 106, and/or the databases 108, 110.

The network 116 is a communications network, such as a local area network (LAN), a wide area network (WAN), or the Internet. When the network 116 is a public network, security features (e.g., VPN/SSL secure transport) may be included to ensure authorized access within the system 100.

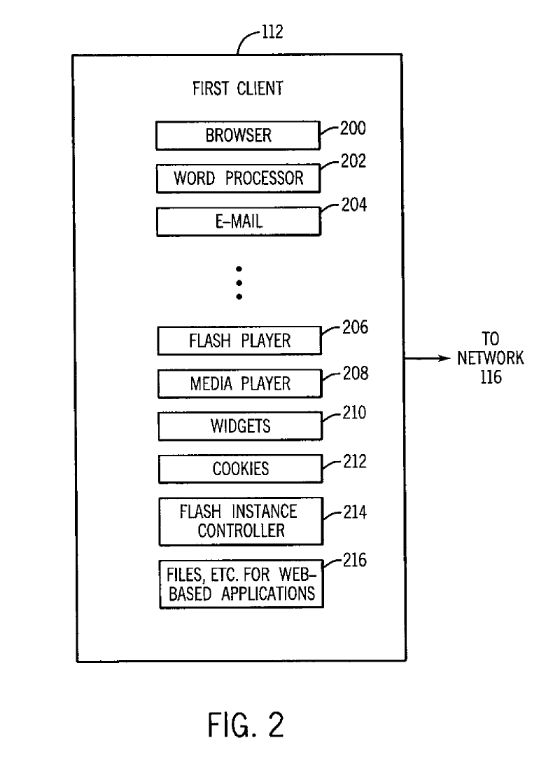

Referring to FIG. 2, a block diagram of one embodiment of the first client 112 including a client side environment and contextual content controller is illustrated. The first client 112 includes a browser application 200, a word processing application 202, an electronic mail (email) application 204, a flash player application 206, a media player application 208, one or more widgets 210, one or more cookies 212, a client side environment and contextual content controller 214, and one or more plug-ins 216. These elements included in the first client 112 (which may be stored in the memory 118) are by no means exhaustive nor are they all required for implementation of embodiments of the present invention. They are provided to facilitate discussion of embodiments of the present invention. The browser application 200, word processing application 202, and email application 204 may collectively be referred to as the local or desktop applications. Each of the flash player application 206, media player application 208, widgets 210, cookies 212, controller 214, and plug-ins 216 may come preloaded on the first client 112 or be downloaded (automatically or upon user request) during communication with the servers 102, 104, or 106.

The controller 214 is also referred to as an environment and contextual content enhancer, facilitator, hub, bridge, or local file system search data bridge. The controller 214 may be a small web format (.swf) file, instance, plug-in, or module executable using the flash player application 206. The software modules discussed herein may include script, batch or other executable files, or combinations and/or portions of such files. The software modules may include a computer program or subroutines thereof encoded on computer-readable media. An example of the flash player application 206 is the Adobe Flash Player version 6.045 or higher.

In one embodiment, the first server 102 may be an instant messaging (IM) server for a first IM service provider; the second server 104 may be an IM server for a second IM service provider; and the third server 106 may be a web browser server. The first and second databases 108, 110 store data pertaining to indexed web pages and user account information as appropriate to provide IM and web browsing functions at the first and second clients 112, 114.

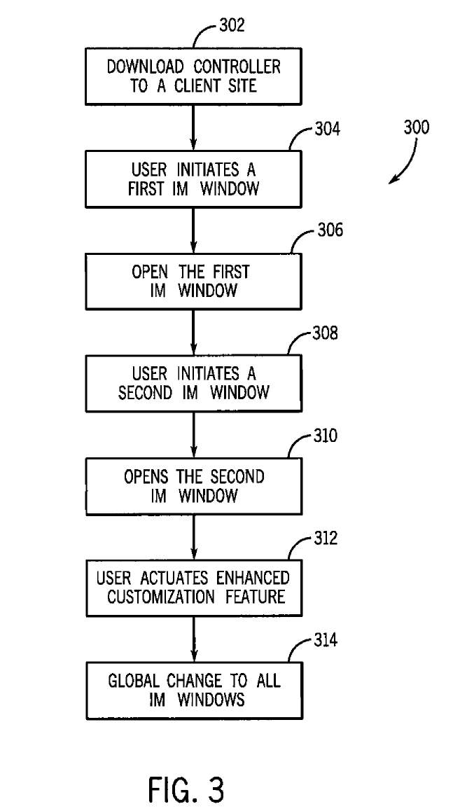

Referring to FIG. 3, a flow diagram 300 illustrates an embodiment of the controller 214 in the context of a web-based IM application. At a block 302, the controller 214 is downloaded to a client site, such as the first client 112, from a host server, such as the first server 102. The download may be automatic when a user accesses the web-based IM application from the first server 102 or it may be upon the user's request. Although not shown, the flash player application 206 and plug-ins 216 may also be downloaded automatically from the first server 102 to the first client 112.

At a block 304, a user at the first client 112 starts a first IM session or window. The web-based IM application accessed from the first server 102 (and other servers and/or databases) provides the first IM window at the first client 112 for the user to communicate with one or more other IM users. The first IM window (also referred to as an IM instance, IM conversation, chat session, or IM session window) is rendered in accordance with default settings specified by the web-based IM application or as specified by the user at a block 306. An example of user specified settings for an IM session window are IMVironments (IMVs) for Y! Messenger. Each IMV is a flash plug-in (file or application) that provides a window environment with its own marketing identity and functionality (such as background color, pattern, or logo). The user may select a particular IMV for the first IM window. The user-selected IMV may be one of the plug-ins 216.

After the first IM session has been initiated, the user may decide to start another IM session at a block 308 (e.g., so that the user can carry out a conversation with a first friend in the first IM window and a separate conversation with a second friend in a second IM window). This second IM window is rendered in accordance with default settings or as specified by an IMV (block 310). Typically an IMV is associated with a given IM window and does not affect multiple IM windows. Each IMV acts independently of each other.

At a block 312, the user decides to customize or add/change a functionality to the IM windows. A panel, button, or other user interface item may be displayed for the user to turn on or enable a change to the IM windows. In response to the user request, the controller 214 is operable to effect a global change to all IM windows at the first client 112 (block 314). The controller 214 comprises a flash instance, plug-in, file, or module that can communicate with any other flash instance on the first client 112. The controller 214 operates as a master or hub to interact with other files or applications that use the flash player 206. The controller 214 provides a customized “look and feel” to the IM windows and/or acts as a controller to enable new global (global to a local client) functionality onto the IM window conversations at the first client 112.

For example, the user may choose to change the IM conversation display from plain text to text bubbles. Even if plain text conversation display is provided as the default setting of the web-based IM application or the IMVs, the controller 214 communicates with other flash files or applications (such as IMVs when IMVs are enabled) to provide text bubbles instead of plain text. This text bubble feature is implemented across multiple IM conversations, such as both of the first and second IM windows.

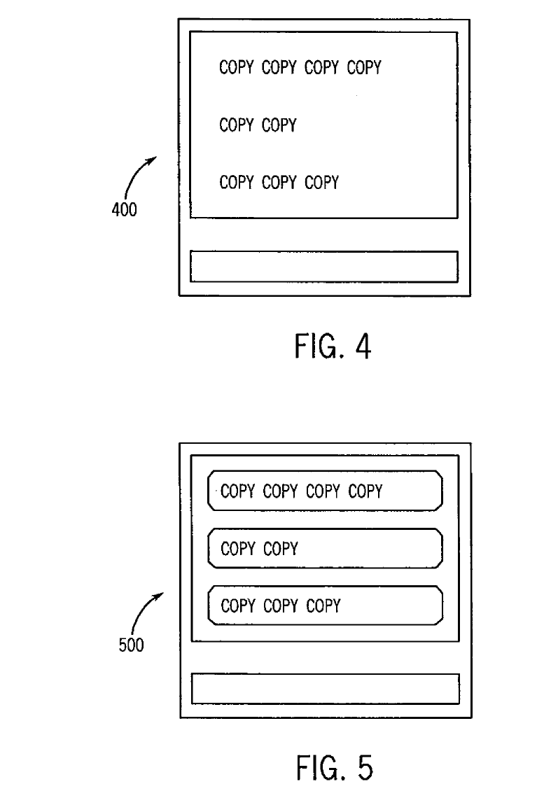

FIGS. 4-5 illustrate invoking speech or text bubbles (also referred to as a bubble view) instead of plain text (also referred to as the default view) in the conversation display of an IM session window. FIG. 4 illustrates a default view 400 and FIG. 5 illustrates a bubble view 500. Although not shown, if the conversation display shown in FIG. 5 is part of the first IM window, then the conversation display of the second IM window (and any other IM window provided by the web-based IM application at the first client 112) would also be in bubble view.

The features provided by the controller 214 can be turned on or off. Hence, the controller 214 need not be actively communicating or otherwise affecting other flash files if no customization is requested. Alternatively, if the controller 214 is configured to automatically push features, content, and/or functionalities to one or more clients, then the controller 214 may affect other flash instances or files to provide the features, content, and/or functionalities. The controller 214 does not require network connectivity to function and/or communicate with any other flash instance that is locally or client side located. The controller 214 is operable to act as a bridge that manipulates multiple flash instances to cause widespread visual organization/uniformity.

One or more blocks in the flow diagram 300 may occur simultaneously or in different order than illustrated. For example, the block 312 may occur before blocks 308, 310. The initiation of the customization feature in the block 312 can occur before the user request for a second IM window, and when the second IM window opens, this window will include the customization feature, e.g., bubble text view rather than the default view. Although FIG. 3 is discussed with respect to a web-based IM application, the application may be other types of web-based applications, such as a web-based e-mail application like Yahoo! Mail, or desktop applications, such as Outlook or Thunderbird.

In another embodiment, the controller 214 can communicate and affect a variety of flash instances at the first client 112, including those associated with the web-based IM application, browser application 200, and/or desktop applications. The controller 214 can provide the same or complementary contextual content across these different applications. The controller 214 can use activity in one application to specify (or drive) expanded feature, content, and/or functionalities in other application(s). Due to the ability of the controller 214 to inject non-native functionalities into other flash instances, the controller 214 may be a revenue generator.

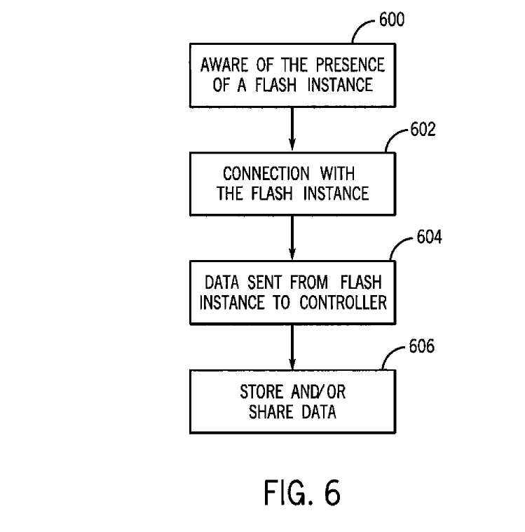

Referring to FIG. 6, when the user opens an application with flash content, the controller 214 becomes aware of the presence of such flash content (block 600). The controller 214 makes a connection with such flash content (block 602). At a block 604, once the connection or coupling is made, data relating to user activity at the application (or some state of the application) can be sent from the flash content to the controller 214. The controller 214 may specify the types of data to be received. User activity may be, for example, user searches on a browser application, or web pages requested either by URL address or by clicking. At a block 606, the sent data is stored for later use and/or immediately shared with other applications or windows at the client side device. Based upon data that was aggregated through previous activity, the controller 214 may provide a feature, content, and/or functionality to the user's present session that is meaningful, accurate, and contextual.

For example, the user may be multi-tasking at the first client 112, such as performing a search using a first instance of the browser application 200, having an IM chat session using the web-based IM application running at a second instance of the browser application 200, and have the e-mail application 204 open. The controller 214 can be configured to provide a particular contextual advertisement or marketing content (e.g., an advertisement banner) to the bottom of the opened IM session window. The controller 214 may communicate with the web-based IM application or an IMV selected by the user for the given IM window. Since the controller 214 is aware that there are other flash instances running on the first client 112, the controller 214 can also communicate and cause the display of such contextual advertisement to the search web page on the first instance of the browser application 200 and an open e-mail message on the e-mail application 204. Thus, the controller 214 has the ability to synchronize new content between different flash instances.

IM users typically start running the web-based IM application on their local devices at the start of the day and keep it turned “on” for the rest of the day. This is done so that they can communicate with friends, family, or coworkers on a real-time basis and so that they can indicate their availability to participate in chat sessions. The controller 214 takes advantage of the IM application's continual “on” state to potentially distribute targeted marketing content (or other feature, content, and/or functionality) to more than just the IM application and if possible, other applications running on the local devices.

As another example, the user may run a search using the first instance of the browser application 200. The controller 214 monitors the search terms and/or the search results viewed by the user. The controller 214 uses this monitored information to distribute (and place) appropriately targeted marketing content on other applications at the first client 112. The controller 214 can either have a limited number of marketing content stored at the first client 112 (perhaps content from paid sponsors, companies or advertisers, which is updated on a periodic basis from a server over the network 116), or the marketing content to be placed may be obtained from a server over the network 116 once the controller 214 knows what content would be most relevant. Accordingly, the bottom of an IM chat window could display the targeted marketing content, a web-based email application also open at the client site could display the targeted marketing content (either in the Inbox page and/or in each composing e-mail window), and/or a window of a desktop application could include the targeted marketing content.

As another example, the search driven example above may cause the controller 214 to provide a customization feature, such as a unique font or background pattern or toolbar, which the user can toggle on or off in the other applications. The controller 214 may be configured in a variety of ways to enhance the user experience, including providing the option to turn something off.

In this manner, the controller 214 maintains a persistent presence at and exchanges data within the first client 112 to minimize or avoid network bandwidth issues, security issues (e.g., if the controller 214 resided on the server side or required network connectivity, then external security breaches are more likely), or interruptions caused by external sources. Also, unlike cookies, the controller 214 comprises a flash instance and is less susceptible to filters, blockers, and other settings at the first client 112 likely to prevent download of the controller 214 or deletion of the controller 214 after download. The controller 214 communicates and controls flash files associated with web-based or desktop applications (or more than one window of a given application) at the first client 112 to the extent that new and/or replacement features, content, and/or functionalities that the controller 214 wishes to provide to the user at the first client 112 is desired. The controller 214 can obtain dynamic data from a server over the network 116 to provide at the first client 112 or the data provided at the first client 112 can be previously locally stored data. The controller 214 provides a one-to-many factor to foster user-driven customization, promote better user experience, and/or to open avenues for monetization.

The controller 214 has a persistent presence at a client device to act as a bridge for manipulating multiple flash instances to cause organized or uniform visual presentation and/or to act as a bridge for aggregating and sharing data between multiple flash instances for immediate and/or later use across windows of a single application or across multiple applications. The controller 214 can globally insert features, content, and/or functionalities across more than one application (or more than one window of a given application) at a client side device. Examples include speech or text bubbles, background colors or patterns, bitmap logos, advertisement, toolbars, unique fonts, or other data that may be used for graphical display. Such global enablement is possible even when the affected applications/windows are themselves not compatible or capable of communicating with each other. The controller 214 enables features, content, and/or functionalities by controlling flash instance(s) associated with applications or application windows at the client side device (whether the flash instances relate to operation of a browser application, web-based applications, desktop applications, or are multi-layers in a given application such as IMVs) to insert new features and/or substitute existing features already provided by the flash instances to the applications or windows with the controller's features.

Thus, the controller 214 takes advantage of the widespread use of the flash player, and correspondingly the use of flash instances, to insert desired features using other existing flash instances. The controller 214 is also operating system independent. The controller 214 is operable in any client device that has a flash player application regardless of whether the client device runs on the Linux, Sun, Windows, Apple, or other operating system.

It will be appreciated that the above description for clarity has described embodiments of the invention with reference to different functional units. However, it will be apparent that any suitable distribution of functionality between different functional units may be used without detracting from the invention. Hence, references to specific functional units are only to be seen as references to suitable means for providing the described functionality rather than indicative of a strict logical or physical structure or organization.

The invention can be implemented in any suitable form including hardware, software, firmware or any combination thereof. Different aspects of the invention may be implemented at least partly as computer software or firmware running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

The terms “computer program product,” “computer-readable medium,” and the like may be used generally to refer to media such as, for example, database 108, server 102, or memory 118. These and other forms of computer-readable media may be involved in storing one or more sequences of one or more instructions for use by the first client 112 to perform specified operations. Such instructions, generally referred to as “computer program code” (which may be grouped into the form of computer programs or other groupings), when executed, enable the system 100 to perform features or functions of embodiments of the present invention. Note that the code may directly cause the processor to perform specified operations, be compiled to do so, and/or be combined with other software, hardware, and/or firmware elements to do so.

Moreover, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A computer-implemented system, comprising:
a server configured to provide a first plug-in, a second plug-in, and a web-based application; and
a client operably coupled to the server, the client operable to access from the server the first plug-in and the web-based application, and to locally store the second plug-in,
wherein the first plug-in is associated with the web-based application and provides at least one customization to a first window instance of the web-based application accessed at the client, and
wherein the second plug-in is operable to communicate with the first plug-in to cause at least one feature absent in the first plug-in to be provided to the first window instance of the web-based application accessed at the client.

2. The system of claim 1, wherein the web-based application comprises a web-based instant messaging application.

3. The system of claim 1, wherein the web-based application comprises a web-based electronic mail application.

4. The system of claim 1, wherein each of the first plug-in and the second plug-in comprises a flash player technology-based file.

5. The system of claim 1, wherein the at least one customization comprises a window environment feature.

6. The system of claim 1, wherein a third plug-in associated with the web-based application is accessed from the server to the client, the second plug-in further operable to communicate with the third plug-in to cause the at least one feature to be provided to a second window instance of the web-based application accessed at the client, wherein the at least one feature is absent in the third plug-in.

7. A computer-implemented method, the method comprising:
controlling a second flash file and a third flash file using a first flash file to cause a feature, content, or functionality from the first flash file to be present at a second application associated with the second flash file and a third application associated with the third flash file, wherein the feature, content, or functionality is not present in the second and third flash files;
presenting a window of the second application including the feature, content, or functionality; and
presenting a window of the third application including the feature, content, or functionality.

8. The method of claim 7, further comprising:
monitoring user activity; and
selecting the feature, content, or functionality that is an approximate contextual fit with the monitored user activity.

9. The method of claim 7, wherein the second application comprises a web-based application.

10. The method of claim 9, wherein the third application comprises a local application residing at a client.

11. The method of claim 9, wherein the second application comprises a web-based instant messaging application and the second flash file comprises an environment customization file.

12. The method of claim 7, wherein the second application comprises an instant messaging application.

13. The method of claim 7, wherein the first flash file is activated upon user request.

14. The method of claim 7, wherein the first flash file has a persistent presence at a client.

15. A computer-readable medium comprising instructions for modularly expanding user experience over a network comprising:
providing a flash player technology-based module;
automatically adding a feature to a first application using the module, wherein the feature is not included in the first application;
automatically adding the feature to a second application using the module, wherein the feature is not included in the second application;
presenting the first application including the feature; and
presenting the second application including the feature, wherein each of the first and second applications uses flash player technology to present the feature.

16. The computer-readable medium of claim 15, further comprising:
automatically suppressing another feature provided by the first application to automatically add the feature to the first application.

17. The computer-readable medium of claim 15, further comprising:
tracking user activity at a third application prior to automatically adding the feature to the first and second applications;
determining the feature based on relevancy to the tracked user activity; and
initiating automatically adding the feature to the first and second applications.

18. The computer-readable medium of claim 17, wherein the third application comprises a browser, the first application comprises a web-based application, and the third application comprises a desktop application.

19. The computer-readable medium of claim 15, wherein the first application comprises a web-based application and the second application comprises a local application.

20. The computer-readable medium of claim 19, wherein a first flash instance is associated with the first application, and the automatically adding the feature to the first application comprises the module controlling the first flash instance to cause presentation of the feature.

21. An apparatus for providing secure data exchange comprising logic operable to:
communicate with a first flash instance;
obtain first data from the first flash instance;
communicate with a second flash instance; and
provide at least some of the first data obtained from the first flash instance to the second flash instance.

22. The apparatus of claim 21, further comprising logic operable to store the data obtained from the first flash instance.

23. The apparatus of claim 21, further comprising logic operable to:
obtain second data from the second flash instance; and
provide at least some of the second data obtained from the second flash instance to the first flash instance.

24. The apparatus of claim 23, wherein the first flash instance is associated with a first application and the second flash instance is associated with a second application.

25. The apparatus of claim 23, wherein the first flash instance is associated with a first window of an application and the second flash instance is associated with a second window of the application.

26. The apparatus of claim 21, wherein the first data comprises user activity information.

27. The apparatus of claim 21, wherein at least some of the first data comprises one of visual content or user interface functionality.

28. The apparatus of claim 21, wherein the logic operable to communicate with the first flash instance comprises logic operable to communicate within a local device.
